(19) United States
(12) Patent Application Publication
(10) Pub. No.: US 2008/0024929 A1
(43) Pub. Date: Jan. 31, 2008

(54) Method and apparatus preventing slider separation from disk surface contact start-stop hard disk drive

(76) Inventors: Andrei Khurshudov, San Jose, CA (US); Brian D. Strom, Cupertino, CA (US)

Correspondence Address: GREGORY SMITH & ASSOCIATES, 3900 NEWPARK MALL ROAD, 3RD FLOOR, NEWARK, CA, 94560, US

(21) Appl. No.: 11/497,554

(22) Filed: Jul. 31, 2006

(51) Int. Cl. G11B 5/54

(52) U.S. Cl. 360/254.7

(57) ABSTRACT

Parking sliders on disk surfaces by a load tab contacting a tab ramp to engage sliders into secure contact. Head gimbal assemblies including these load tabs; the disk clamp, disk spacer, spindle motors, each including at least one tab ramp; the hard disk drive, their manufacturing processes and the products of those processes.

### TECHNICAL FIELD

This invention relates to apparatus and methods of maintaining a hard disk drive when in a non-operational mode, in particular to apparatus and methods improving non-operating shock robustness by preventing separation of sliders from media in Contact Start-Stop (CSS) hard disk drives.

### BACKGROUND OF THE INVENTION

The invention focuses on Contact Start-Stop (CSS) hard disk drives. From hereon, a hard disk drive will be assumed to be a CSS hard disk drive. These hard disk drives are faced with several problems, some of which occur while a hard disk drive is not operating as a memory access device, which will be known herein as its non-operational mode.

These hard disk drives can experience mechanical shock events that propagate through their head stack assembly and cause at least one slider to bounce away from a disk. Inevitably, the slider swings back toward the disk and impacts the surface at one or more of the slider corners. These slider corner impacts produce dents in the disk surface and associated raised furrows around the dents. If the shock event occurs while the sliders are parked (non-operating shock), these dents and furrows are produced in the start-stop landing zone.

During subsequent start-stop cycles, the sliders rub on these raised furrows while the disks accelerate to target speed (on start) or decelerate to rest (upon stop). Because contact pressures are high when rubbing on the raised furrows, these regions of the disk wear quickly, which exposes underlying metallic layers and may result in catastrophic failure. Moreover, the furrows are tall enough to interfere with the slider when at full speed, while the slider would otherwise be flying free of contact. These repeated high speed rubbing/impact events also tend to cause rapid damage.

Read-write head degradation is another failure mode that is associated with start-stop cycling after non-operating shock damage. If the read-write head is positioned such that it contacts the raised furrows around disk dents, the head may be scratched or electrically shorted by smears of metal material worn from the disk.

Prior art methods include mechanical design of a shock-robust hard disk drive, cleverly designed to preclude the sliders separating from the disk during most shock events. Unfortunately, shock robustness goals can conflict with recording performance goals, and compromises are inevitably necessary. Also, mechanical design changes are time consuming and expensive, and cannot be implemented late in the development cycle without slowing product development.

Another prior art technique is to make thicker the protective carbon layers on the disk, thus delaying the exposure of disk metallic material through wear, and also the carbon films on the slider, which may protect the head from damage. Unfortunately both these measures increase overall magnetic spacing and consequently worsen signal resolution during normal operation of the hard disk drive as a memory access device.

### SUMMARY OF THE INVENTION

The invention improves the non-operating shock robustness of a contact start-stop hard disk drive without affecting recording performance. It can be implemented at minimal cost. As mentioned earlier, this invention relates only to contact start-stop hard disk drives, and from hereon in the summary and detailed description, a hard disk drive will be assumed to be a contact start-stop hard disk drive.

For each head gimbal assembly included in the hard disk drive, the head gimbal assembly interacts with a tab ramp radially mounted about a spindle shaft center as follows. A load tab included in the head gimbal assembly contacts the tab ramp to engage the slider into a secure contact with a disk surface. The disk surface is included in a disk mounted through the spindle shaft center. The head gimbal assembly includes the load tab coupling through a load beam to engage the slider, where the load tab engages the tab ramp away from the slider. In the prior art, the load tab engages a load ramp toward the slider, to lift the slider away from the disk surface, rather than securing contact with it. The invention includes manufacturing the head gimbal assembly by coupling the load beam including the load tab through a flexure finger to the slider to create the head gimbal assembly and the head gimbal assembly as the product of that process.

The hard disk drive further operates as follows. Each of the sliders is moved a short distance away from the tab ramps before starting the spindle motor coupling to the disk(s), and each of the sliders is moved the short distance away from the tab ramps before stopping the spindle motor. The short distance is at most one millimeter, and may preferably be about half a millimeter.

The invention includes a disk spacer supporting this method of parking the sliders on disk surfaces by including a first tab ramp radially mounted to a second tab ramp. The invention includes manufacturing the disk spacer, by providing the first tab ramp and second tab ramp to create the disk spacer. The disk spacer is a product of this process.

The invention includes a disk clamp supporting this method parking the sliders on disk surfaces by including a third tab ramp. The invention includes manufacturing the disk clamp by providing the third tab ramp, and the disk clamp as the product of this process.

The invention includes a spindle motor supporting this method parking the sliders on disk surfaces by including a fourth tab ramp. The invention includes manufacturing the spindle motor by providing the fourth tab ramp, and the spindle motor as the product of this process.

The invention includes the hard disk drive implementing this method of parking the sliders on disk surfaces, by including at least one of the disk surfaces for access by at least one of the head gimbal assemblies including the load tab for contact with the tab ramp near a far inside diameter of the disk surface. The hard disk drive may further include a second of the disk surfaces for access by a second of the head gimbal assemblies including a third of the load tabs for contact with a third of the tab ramps near the far inside diameter of the second disk surface. The hard disk drive may further include a disk clamp containing the tab ramp and a spindle motor containing the second tab ramp.

Manufacturing the hard disk drive may include one or more of several processes. First, the hard disk drive including a single disk may preferably be manufactured by rotatably coupling the disk between the disk clamp and the spindle motor about the spindle shaft center, placing the tab ramp close to the disk surface and the second tab ramp close to the second disk surface and installing a head stack assembly including the head gimbal assembly near the disk surface and further including the second head gimbal assembly near the second disk surface to create the hard disk drive.

The hard disk drive may further include a disk spacer including a third of the tab ramps facing the second disk surface and coupling to a fourth of the tab ramps facing a third disk surface included in a second of the disks, a third of the head gimbal assemblies including a third of the load tab for contacting the third tab ramp to engage a third of the sliders into the secure contact of the second disk surface, and a fourth of the head gimbal assemblies including a fourth of the load tabs facing the third disk surface.

Manufacturing this hard disk drive may preferably further include assembling the disk spacer between the third disk surface and the second disk surface by rotatably coupling a spindle motor to the disk and the second disk through the spindle shaft center, and installing a head stack assembly including the third head gimbal assembly and the fourth head gimbal assembly between the third disk surface and the fourth disk surface to create the hard disk drive.

The hard disk drive is a product of the inventions manufacturing processes. The hard disk drive may further include more than two disks and more than one disk spacer. By way of example, the invention's hard disk drive may include three disks separated by two disk spacers.

### BRIEF DESCRIPTION OF THE DRAWINGS

FIG. 1A shows various embodiments of the invention's tab ramp implemented in a disk clamp, a disk spacer and a spindle motor;

FIG. 1B shows the invention's head gimbal assembly at least a sort distance from the tab ramp;

FIG. 1C shows the load tab contacting the tab ramp of the preceding Figures to engage the slider into a secure contact with a disk surface;

FIG. 1D shows the head gimbal assembly including the load tab for contacting the tab ramp away from the slider;

FIGS. 1E and 1F show an example of the invention's hard disk drive including one disk mounted between the invention's disk clamp and the spindle motor;

FIGS. 1G and 1H show an example of the invention's hard disk drive including two disk mounted between the disk clamp and the spindle motor, separated by the invention's disk spacer;

FIGS. 2A and 3 show further details of the hard disk drive;

FIGS. 2B and 4 show further details of the head gimbal assembly; and

FIGS. 5 and 6 show further details of the hard disk drive.

### DETAILED DESCRIPTION

This invention relates to apparatus and methods of maintaining a hard disk drive when in a non-operational mode, in particular to apparatus and methods improving non-operating shock robustness by preventing separation of sliders from media in Contact Start-Stop (CSS) hard disk drives. The invention improves the non-operating shock robustness of a contact start-stop hard disk drive without affecting recording performance. It can be implemented at minimal cost. As mentioned earlier, this invention relates only to contact start-stop hard disk drives, and from hereon in the summary and detailed description, a hard disk drive will be assumed to be a contact start-stop hard disk drive.

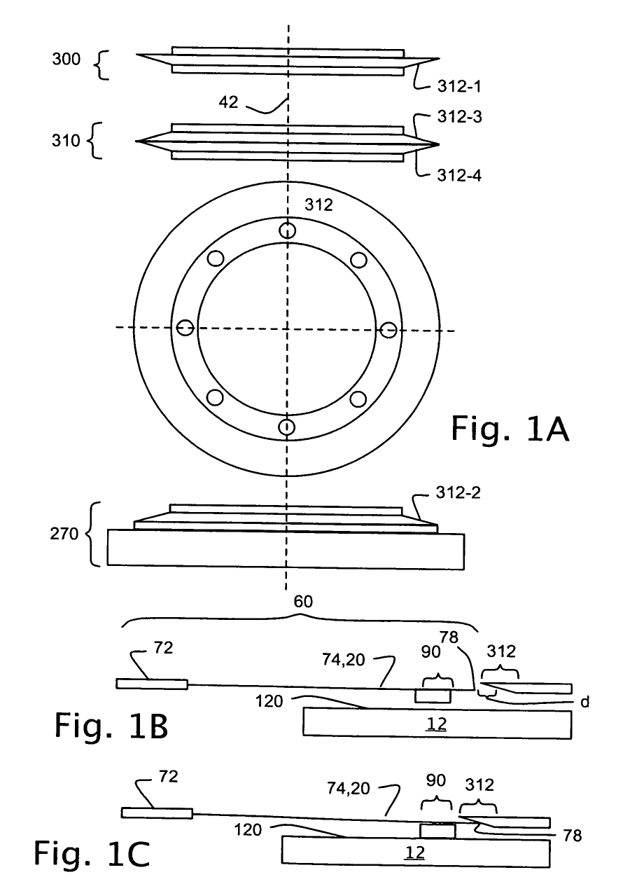

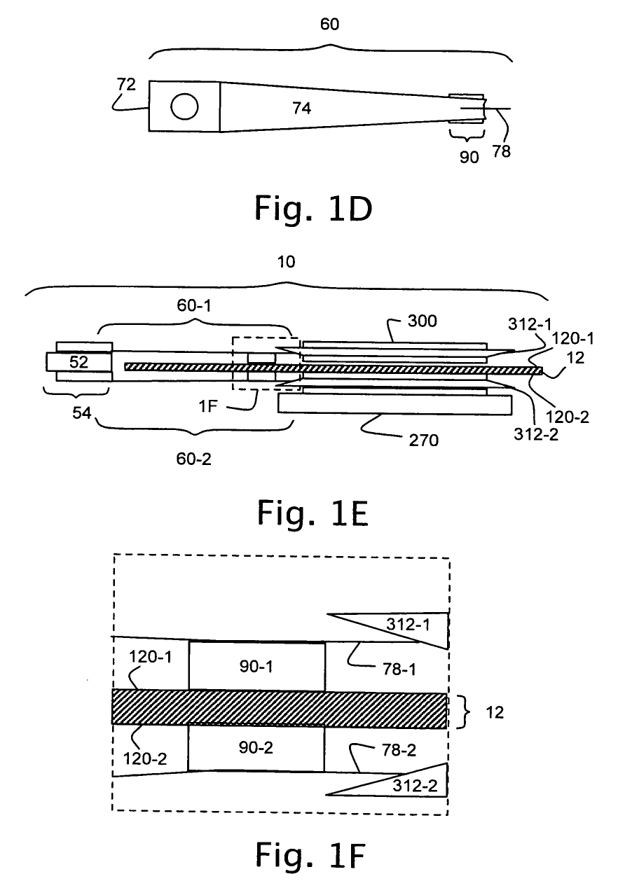

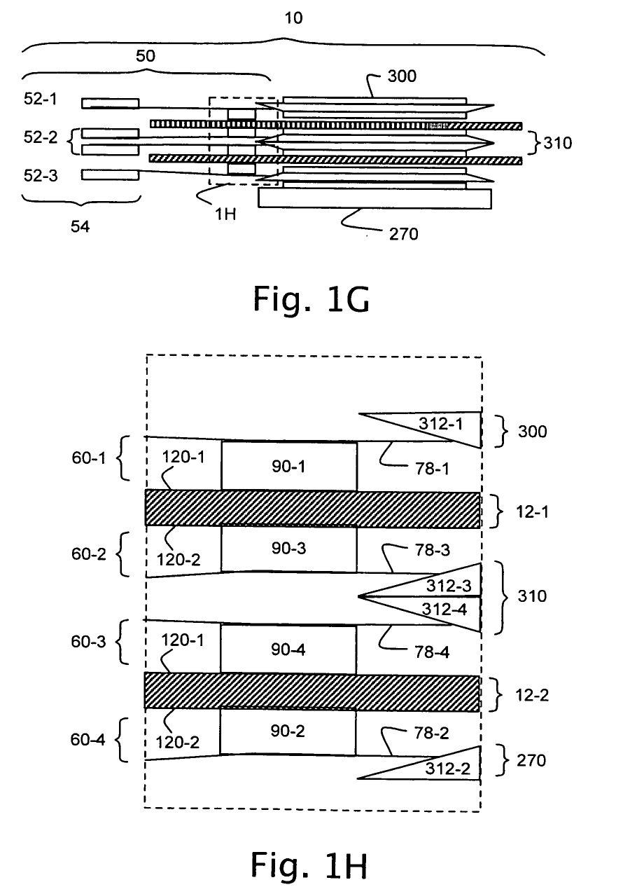

The invention's method of parking the sliders includes, for each head gimbal assembly 60 included in a hard disk drive 10, the head gimbal assembly interacts with a tab ramp 312 radially mounted about a spindle shaft center 42 as follows. A load tab 78 included in the head gimbal assembly contacts the tab ramp to engage the slider 90 into a secure contact with a disk surface 120, as shown in FIGS. 1C, and 1E to 1H. The disk surface is included in a disk 12 mounted through the spindle shaft center. The disk surface may include a disk substrate of nickel-phosphorus clad aluminum.

The invention's head gimbal assembly 60, includes the load tab 78 coupling through a load beam 74 to engage the slider 90, where the load tab contacts the tab ramp away from the slider, as shown in FIG. 1C. In the prior art, the load tab contacts a load ramp toward the slider, to lift the slider away from the disk surface, rather than securing contact with it. The invention includes manufacturing the head gimbal assembly by coupling the load beam including the load tab through a flexure finger 20 to the slider to create the head gimbal assembly and the head gimbal assembly as the product of that process.

FIG. 1A shows various embodiments of the invention's tab ramp 312. These ramps serve as a cam through contacting the load tabs of head gimbal assemblies to engage their sliders into secure contact with their neighboring disk surfaces during non-operation periods.

The invention includes a disk clamp 300 supporting this method of parking the sliders on disk surfaces by including a third tab ramp 312-3 as shown in FIG. 1A. The invention includes manufacturing the disk clamp by providing the third tab ramp, and the disk clamp as the product of this process.

The invention includes a spindle motor 270 supporting this method of parking the sliders on disk surfaces by including a fourth tab ramp 312-4. The invention includes manufacturing the spindle motor by providing the fourth tab ramp, and the spindle motor as the product of this process.

The invention includes a disk spacer 310 supporting this method of parking the sliders on disk surfaces by including a third tab ramp 312-3 radially mounted to a fourth tab ramp 312-4, which form a radially symmetric triangular extension from the disk spacer about the spindle shaft center 42. The invention includes manufacturing the disk spacer, by providing the first tab ramp and second tab ramp to create the disk spacer. The disk spacer is a product of this process.

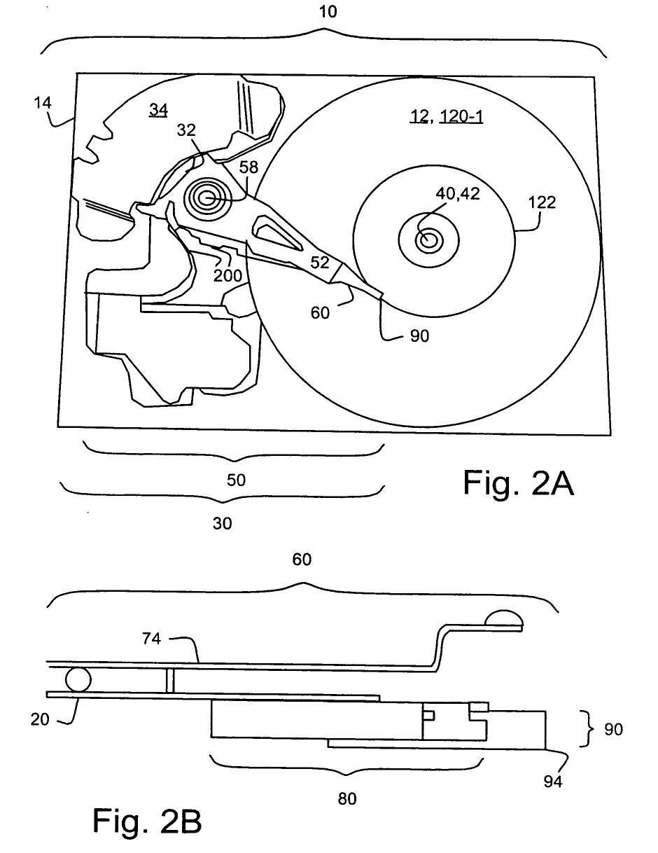

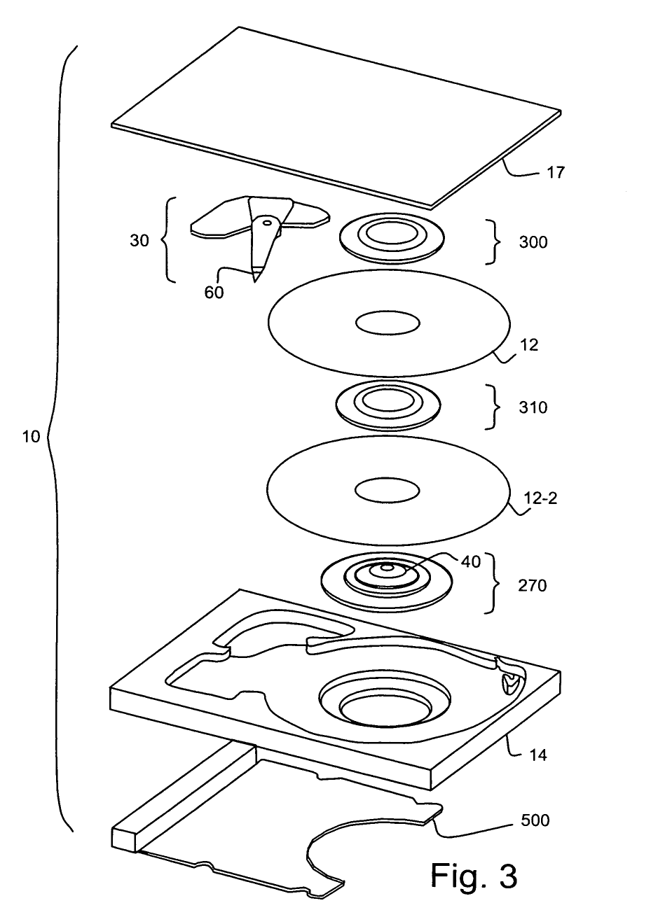

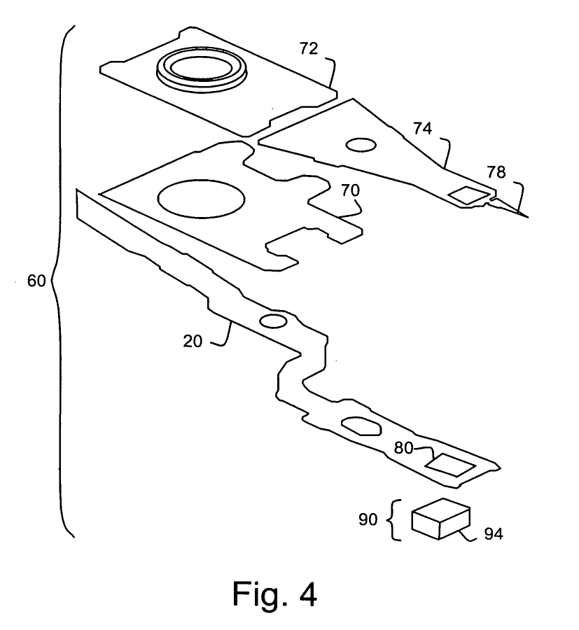

The invention includes the hard disk drive 10 implementing this method of parking the sliders on disk surfaces, by including at least one disk surface 120, for example a first disk surface 120-1 for access by at least one head gimbal assembly 60, for example a first head gimbal assembly 60-1 including the first load tab 78-1 for contact with the first tab ramp 312-1 near a far inside diameter ID of the disk surface as shown in FIG. 2A.

The hard disk drive 10 may further include a second disk surface 120-2 for access by a second head gimbal assembly 60-2 including a third load tab 78-3 for contact with a third tab ramp 312-3 near the far inside diameter ID of the second disk surface. The hard disk drive may further include a disk clamp 300 containing the first tab ramp 312-1 and a spindle motor 270 containing the second tab ramp 312-2.

Manufacturing the hard disk drive may include any combination of several processes. First, the hard disk drive 10 including the first disk 12-1, may preferably be manufactured by rotatably coupling the disk between the disk clamp 300 and the spindle motor 270 about the spindle shaft center 42, placing the first tab ramp 312-1 close to the first disk surface 120-1 and the second tab ramp 312-2 close to the second disk surface 120-2 and installing a head stack assembly 50 including the first head gimbal assembly 60-1 near the first disk surface 120-1 and further including the second head gimbal assembly 60-2 near the second disk surface 120-2 to create the hard disk drive.

The hard disk drive 10 may further include a disk spacer 310 including a third tab ramp 312-3 facing the second disk surface 120-2 and coupling to a fourth tab ramp 312-4 facing a third disk surface 120-3 included in a second disk 12-2, a third head gimbal assembly 60-3 including a third load tab 78-3 for contacting the third tab ramp to engage a third slider 60-3 into the secure contact of the second disk surface, and a fourth head gimbal assembly 60-4 including a fourth load tab 78-4 facing the third disk surface.

By way of example, consider FIG. 1E and its details in FIG. 1F. When in non-operational mode, the invention's contact start/stop hard disk drive 10 parks the head stack assembly 50 with the head gimbal assemblies at the far inside diameter ID, shown in FIG. 2A, on the disk surfaces. The second load tab 78-2 contacts the first tab ramp 312-1 of the disk spacer 310 engaging the second slider 90-2 into secure contact with the second disk surface 120-2. The second load tab 78-3 contacts the second tab ramp 312-2 of the disk spacer engaging the third slider 90-3 into secure contact with the third disk surface 120-3. These tab ramps serve as a cam, contacting the load tabs to engage the sliders in secure contact with the disk surfaces no matter what the angular position of the head stack assembly or hard disk drive. The sliders rest at the far inside diameter and because of the contact between the load tabs and tab ramps, are prevented from separating from the disk surfaces they rest on during a mechanical shock to the hard disk drive.

In further detail, the second load tab 78-2 is included in the second head gimbal assembly 60-2. The third load tab 78-3 is included in the third head gimbal assembly 60-3. The head stack assembly 50 includes a first actuator arm 52-1 coupling to a first head gimbal assembly 60-1 including a first load tab 78-1 for contacting a third tab ramp 78-3 included in a disk clamp 300 to engage the first slider 90-1 into secure contact with the first disk surface 120-1. The head stack assembly further includes a second actuator arm 52-2 coupling to a second head gimbal assembly 60-2 and to a third head gimbal assembly 60-3.

Manufacturing this hard disk drive 10 may preferably further include assembling the disk spacer 310 between the second disk surface 120-2 and the third disk surface 120-3 by rotatably coupling a spindle motor 270 to the first disk 12-1 and the second disk 12-2 through the spindle shaft center 42, and installing a head stack assembly 50 including the third head gimbal assembly 60-03 and the fourth head gimbal assembly 60-4 between the third disk surface and the fourth disk surface 120-4 to create the hard disk drive.

The hard disk drive 10 is a product of the invention's manufacturing processes. The hard disk drive may further include more than two disks and more than one disk spacer. By way of example, the invention's hard disk drive may include three disks separated by two disk spacers.

The hard disk drive 10 may further preferably operate as follows. Each slider 90 is moved a short distance away from its tab ramp 312 before starting the spindle motor 270 coupling to the disk(s) 12, and each of the sliders is moved the short distance away from the tab ramps before stopping the spindle motor. The short distance is at most one millimeter, and may preferably be about half a millimeter.

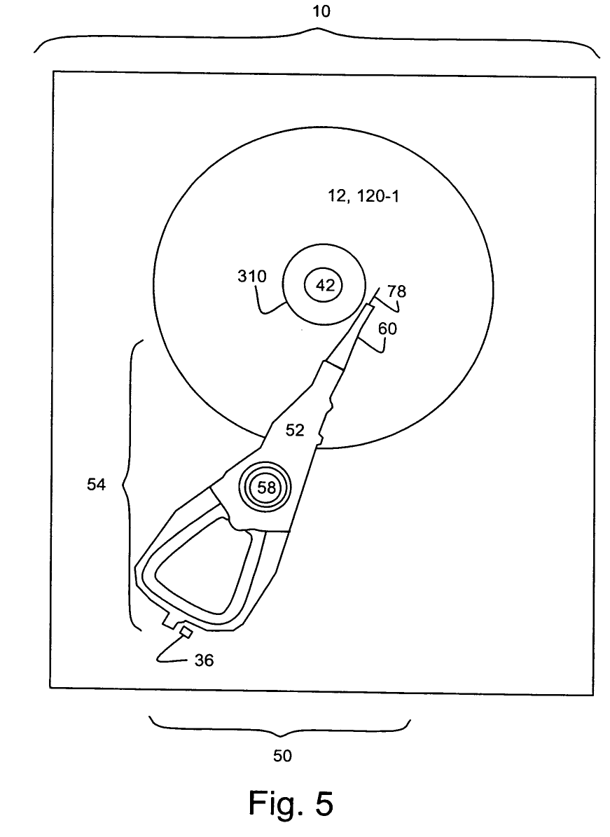

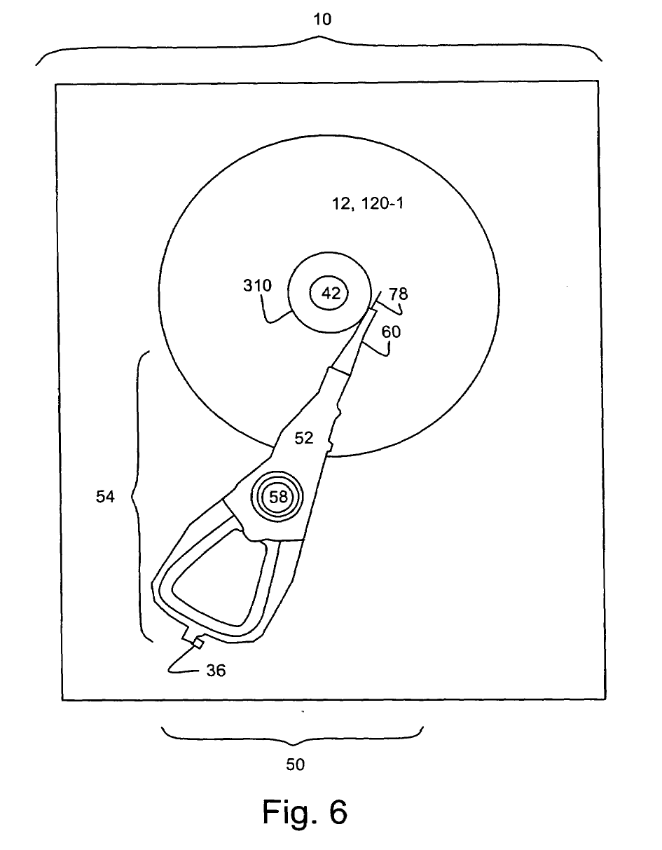

During starting and stopping of the hard disk drive 10, the sliders, such as the second slider 90-2 and the third slider 90-3 are preferably moved slightly away from the tab ramp 312 a short distance d to relieve the load applied by the load tabs contacting the tab ramps before the spindle motor 270 is turned on to rotate the disks, for example, the first disk 12-1 and the second disk 12-2. The short distance may preferably be about ½ millimeter. These operations prevent weakening the durability of the hard disk drive 10. This movement may be accomplished through biasing the voice coil motor 30 against an inside diameter crash stop 36 as shown in FIG. 5. Alternatively, the hard disk drive may include a two position latch mechanism where FIG. 5 shows activating a solenoid coil located at the inside diameter crash stop to attract one or more small magnets located in the actuator tail leading to their contact in FIG. 6.

In normal operation the head stack assembly 50 pivots through an actuator pivot 58 to position at least one read-write head 94, embedded in a slider 90, over a rotating disk surface 120. The data stored on the rotating disk surface is typically arranged in concentric tracks. To access the data of a track 122, a servo controller first positions the read-write head by electrically stimulating the voice coil motor 30, which couples through the voice coil 32 and an actuator arm 52 to move a head gimbal assembly 60 in lateral positioning the slider close to the track as shown in FIG. 2A. Once the read-write head is close to the track, the servo controller typically enters an operational mode known herein as track following. It is during track following mode that the read-write head is used to access the data stored of the track.

In further detail, FIG. 2B shows a side view of the head gimbal assembly 60 with a micro-actuator assembly 80 for aiding in laterally positioning of the slider 90. In certain embodiments, the micro-actuator assembly may employ a piezoelectric effect and/or an electrostatic effect and/or a thermal mechanical effect. The head gimbal assembly may preferably includes a base plate 72 coupled through a hinge 70 to the load beam 74. Often the flexure finger 20 is coupled to the load beam and the micro-actuator assembly 80 and slider 90 are coupled through the flexure finger to the head gimbal assembly.

The invention also includes a head stack assembly 50 containing at least one head gimbal assembly 60 coupled to a head stack 54 at least one actuator arm 52 as shown in FIGS. 1E, 1G, and 5. The head stack assembly 50 may include more than one head gimbal assembly 60 coupled to the head stack 54. By way of example, FIG. 1G shows the head stack assembly coupled with a second head gimbal assembly 60-2, a third head gimbal assembly 60-3 and a fourth head gimbal assembly 60-4, and further includes a second actuator arm 52-2 and a third actuator arm 52-3, with the second actuator arm coupled to the second head gimbal assembly 60-2 and a third head gimbal assembly 60-3, and the third actuator arm coupled to the fourth head gimbal assembly 60-4. The second head gimbal assembly includes the second load tab 78-2 for engaging the second slider 90-2. The third head gimbal assembly includes the third load tab 78-3 for engaging the third slider 90-3. And the fourth head gimbal assembly includes the fourth load tab 78-4 for engaging a fourth slider 90-4.

The preceding embodiments provide examples of the invention and are not meant to constrain the scope of the following claims.

What is claimed is:

1. A method of operating a head gimbal assembly interacting a tab ramp radially mounted about a spindle shaft center in a contact start-stop hard disk drive, comprising, for each head gimbal assembly included in said contact start-stop hard disk drive, the steps:
a load tab contacting said tab ramp to engage a slider into secure contact with a disk surface included in a disk mounted through said spindle shaft center; wherein said head gimbal assembly includes said load tab coupling through a load beam to engage said slider.

2. The method of claim 1, further comprising the steps:
moving each of said sliders a short distance away from said tab ramps before starting a spindle motor coupling to said disk; and
moving each of said sliders said short distance away from said tab ramps before stopping said spindle motor.

3. The method of claim 2, wherein said short distance is at most one millimeter.

4. A disk spacer supporting the method of claim 1, comprising: a first of said tab ramps radially mounted to a second of said tab ramps.

5. A method of manufacturing said disk spacer of claim 10, comprising the step: providing said first tab ramp and said second tab ramps to create said disk spacer.

6. The disk spacer as a product of the process of claim 11.

7. A disk clamp supporting the method of claim 1, comprising: a third of said tab ramps.

8. A method of manufacturing said disk clamp of claim 10, comprising the step: providing said third tab ramp to create said disk clamp.

9. The disk clamp as a product of the process of claim 11.

10. A spindle motor supporting the method of claim 1, comprising: a fourth of said tab ramps.

11. A method of manufacturing said spindle motor of claim 10, comprising the step: providing said fourth tab ramp to create said spindle motor.

12. The spindle motor as a product of the process of claim 11.

13. The head gimbal assembly of claim 1, comprising: said load tab coupling through said load beam to engage said slider; wherein said load tab contacts said tab ramp away from said slider.

14. A method of manufacturing said head gimbal assembly of claim 13, comprising the step:
coupling said load beam including said load tab through a flexure finger to said slider to create said head gimbal assembly.

15. The head gimbal assembly as a product of the process of claim 14.

16. The contact start-stop hard disk drive of claim 1, comprising: at least one disk including:
at least one of said disk surfaces for access by at least one of said head gimbal assemblies including said load tab for contact with said tab ramp near a far inside diameter of said disk surface.

17. The contact start-stop hard disk drive of claim 16, wherein said disk, further includes:
a second of said disk surfaces for access by a second of said head gimbal assemblies including a third of said load tabs for contact with a third of said tab ramps near said far inside diameter of said second disk surface.

18. The contact start-stop hard disk drive of claim 17, further comprising:
a disk clamp containing said tab ramp; and
a spindle motor containing said second tab ramp.

19. The contact start-stop hard disk drive of claim 16, further comprising:
a disk spacer including a third of said tab ramps facing said second disk surface and coupling to a fourth of said tab ramps facing a third disk surface included in a second of said disks;
a third of said head gimbal assemblies including a third of said load tab for contacting said third tab ramp to engage a third of said sliders into said secure contact of said second disk surface; and
a fourth of said head gimbal assemblies including a fourth of said load tabs facing said third disk surface.

20. The contact start-stop hard disk drive of claim 19, further comprising: a third of said disks separated of a second of said disk spacers.

21. A method of manufacturing said contact start-stop hard disk drive of claim 19, comprising the steps:
assembling said disk spacer between said third disk surface and said second disk surface by rotatably coupling a spindle motor to said disk and said second disk through said spindle shaft center;
installing a head stack assembly including said third head gimbal assembly and said fourth head gimbal assembly between said third disk surface and said fourth disk surface to create said contact start-stop hard disk drive.

22. The contact start-stop hard disk drive as a product of the process of claim 21.

23. The contact start-stop hard disk drive of claim 16, wherein said disk, further includes:
a second of said disk surfaces for access by a second of said head gimbal assemblies including a third of said load tabs for contact with a third of said tab ramps near said far inside diameter of said second disk surface.

24. The contact start-stop hard disk drive of claim 23, further comprising:
a disk clamp containing said tab ramp; and
a spindle motor containing said second tab ramp.

25. A method of manufacturing said contact start-stop hard disk drive of claim 24, comprising the steps:
rotatably coupling said disk between said disk clamp and said spindle motor about said spindle shaft center, placing said tab ramp close to said disk surface and said second tab ramp close to said second disk surface;
installing a head stack assembly including said head gimbal assembly near said disk surface and further including said second head gimbal assembly near said second disk surface to create said contact start-stop hard disk drive.

26. The contact start-stop hard disk drive as a product of the process of claim 25.
